(19) United States
(12) Patent Application Publication
(10) Pub. No.: US 2018/0194078 A1
(43) Pub. Date: Jul. 12, 2018

(54) 3D PRINTING PEN AND POWER SUPPLY UNIT THEREOF

(71) Applicant: Shenzhen Soyanpower New Energy Co., Ltd., Shenzhen City (CN)

(72) Inventor: SHIHUA XIE, Shenzhen City (CN)

(21) Appl. No.: 15/494,442

(22) Filed: Apr. 21, 2017

Related U.S. Application Data
(63) Continuation-in-part of application No. PCT/CN2017/070935, filed on Jan. 12, 2017.

(51) Int. Cl. B29C 67/00; B33Y 30/00; B33Y 50/02

(52) U.S. Cl. CPC B29C 67/0088; B29C 67/0081; B29K 2105/16; B33Y 50/02; B33Y 30/00

(57) ABSTRACT

A 3D printing pen and power supply unit is provided. The 3D printing pen includes a printing pen body. The printing pen body includes a first shell, a first electrical interface, a printing circuit, and a printing part arranged in the first shell; wherein, the first electrical interface is coupled electrically with the printing circuit and configured to electrically couple with a battery, a first material inlet and a first material channel are arranged in the first shell, and the first material inlet, the first material channel and the printing part are communicated in order; the printing pen body and the battery are combined into a whole at least when the 3D printing pen is printing. Through the method above, the 3D printing pen of the present disclosure can be powered by the internal electric energy directly to work, without connection to the external power supply all the time.

### CROSS REFERENCE TO RELATED APPLICATIONS

This is a continuation-in-part of International Application PCT/CN2017/070935, with an international filing date of Jan. 12, 2017, which is hereby incorporated by reference herein as if set forth in its entirety.

### TECHNICAL FIELD

The present disclosure relates to the field of 3D (3-dimensional) printing, especially a 3D printing pen and power supply unit thereof.

### BACKGROUND

3D printing is one of rapid prototyping technologies. It is a technology to create an object, in a manner of layer-by-layer printing, using materials that could be glued, such as metal or plastic powder, based on digital model file.

3D printing is achieved through a material printer of digital technology generally. It is usually used to manufacture models in the fields of mold manufacturing, industrial design, etc. Later, it is gradually applied to the direct manufacturing of some products, and there have been some parts and components printed by such technology. This technology is also applied to jewelry, shoes, industrial design, architecture, engineering and construction (AEC), automobile, aerospace, dentistry and medical industry, education, geographic information system, civil engineering, firearms and other fields.

At present, 3D printing devices have entered into an era of portability. The emergence of 3D printing pens accelerates the popularization of 3D printing. However, the current 3D printing pens may be powered and used only after being connected with an external power supply through a plug wire. They must be connected to the external power supply all the time in writing and printing process, which greatly limits the degree of freedom of writing and printing and largely affects the portability of 3D printing pens.

### SUMMARY

The embodiment of the present disclosure provides a 3D printing pen and power supply unit thereof. The power supply unit can supply power for the printing pen without additional plug wire, so the degree of freedom of writing and printing is improved.

The embodiment of the present disclosure provides a 3D printing pen, including a printing pen body. The printing pen body includes a first shell, a first electrical interface, a printing circuit, and a printing part arranged in the first shell.

Wherein, the first electrical interface is coupled electrically with the printing circuit and configured to electrically couple with a battery, a first material inlet and a first material channel are arranged in the first shell, and the first material inlet, the first material channel and the printing part are communicated in order.

The printing pen body and the battery are combined into a whole at least when the 3D printing pen is printing.

Optionally, the printing pen body is provided with a battery compartment holding the battery, and the first electrical interface is arranged in the battery compartment.

Optionally, the battery compartment is an open slot defined in the first shell, the open slot is defined by a bottom wall and side walls, at least one of the side walls of the open slot is provided with a first engaging part, the battery is provided with a second engaging part, and the battery is accommodated detachably in the open slot through the first engaging part and the second engaging part.

Optionally, the first electrical interface and the first engaging part are arranged separately.

Optionally, the first electrical interface is used as the first engaging part.

Optionally, a first groove and a second groove are disposed in the first engaging part, the first groove is defined at a side wall of the open slot, the second groove is defined at another side wall of the open slot, which is opposite to the one provided with the first groove, and the second engaging part comprises a first protrusion and a second protrusion , the first protrusion is arranged at a side of the battery, and the second protrusion is arranged at another side of the battery, which is opposite to the one provided with the first protrusion.

The first groove is matched with the first protrusion, and the second groove is matched with the second protrusion so as to fix the battery to the battery compartment.

Optionally, the 3D printing pen includes a spring sheet arranged at the bottom of the open slot close to the second groove, the spring sheet protrudes from the bottom of the open slot in free state; the second protrusion can retract into the battery, and protrude from the battery in the free state.

The printing pen body is provided with a switch, and the second protrusion retracts into the battery when the switch is pressed, so that the battery is bounced by the spring sheet.

Optionally, the first electrical interface includes a third protrusion which protrudes from the bottom of the open slot and is close to the first groove; the battery is provided with a third groove at the position corresponding to the third protrusion; the third groove passes through the side and the bottom of the battery and is internally provided with a second electrical interface used for coupling the first electrical interface electrically.

The third protrusion can be inserted into the third groove so as to make the first electrical interface connected to the second electrical interface.

Optionally, a third electrical interface is arranged in the first shell and used to supply power for the printing pen body and/or charging the battery.

Optionally, the third electrical interface is coupled with the printing circuit and used to supply power for the printing pen body and/or charging the battery through the printing circuit.

Optionally, the 3D printing pen further includes a charging circuit coupled electrically with the printing circuit.

Optionally, the printing pen body includes a third engaging part arranged in the first shell.

The battery includes a second shell, a fourth engaging part, a cell, the second electrical interface and the third electrical interface, the second electrical interface, the cell and the third electrical interface are coupled electrically in order, and the second electrical interface is used to couple with voltage source electrically.

The battery and the printing pen body are combined into a whole through the third engaging part and the forth engaging part, and the second electrical interface is used to couple with the first electrical interface electrically.

Optionally, a second material inlet, a second material channel and a material outlet are arranged in the battery and are communicated in order, and the material outlet is used to communicate with the first material inlet.

Optionally, the printing pen body includes a heating head, a fuse guide device and a driving device, wherein the heating head and the driving device are coupled electrically with the printing circuit respectively, and the fuse guide device is coupled electrically with the driving device.

Optionally, the 3D printing pen further includes a battery management circuit coupled electrically with the printing circuit.

Specifically, the battery management circuit includes an overcurrent protection circuit and an overvoltage protection circuit; and/or a boost circuit and a buck circuit.

Optionally, when the printing circuit fails to detect the printing order beyond a first preset time, it will turn off power consumption function so that the printing pen body enters a low power consumption mode.

Optionally, if the battery detects that the duration of the printing circuit in the low power consumption mode exceeds a second preset time, it will turn off boost function.

The embodiment of the present disclosure also provides a power supply unit for 3D printing pen, including: a shell, an engaging part, a cell and an electrical interface; wherein the cell is located in the shell, the engaging part and the electrical interface are fixed to the shell, and the electrical interface and the cell are coupled electrically; wherein, the printing pen body and the power supply unit are combined into a whole through the engaging part at least when the 3D printing pen is printing, so that the electrical interface is coupled electrically with the printing pen body.

Optionally, a material inlet, a material channel and a material outlet are arranged in the power supply unit for 3D printing pen and are communicated in order; the material outlet is used to communicate with the printing pen body.

Compared with the prior art, the embodiment of the present disclosure has the beneficial effects of making the 3D printing pen able to work properly without additional plug wire through combining the battery into the 3D printing pen, overcoming the problem that the writing and printing scope is limited due to connection of the external power supply through plug wire when the 3D printing pen works, enhancing, and improving the degree of freedom and the portability of the 3D printing pen.

### BRIEF DESCRIPTION OF THE DRAWINGS

FIG. 1 is a side view of one embodiment of the 3D printing pen in the present disclosure;

FIG. 2 is a side view of another embodiment of the 3D printing pen in the present disclosure;

FIG. 3 is a circuit diagram of one embodiment of the 3D printing pen in the present disclosure;

FIG. 4 is a perspective view of the printing pen body of one embodiment of the 3D printing pen in the present disclosure;

FIG. 5 is another stereoscopic diagram of the printing pen body of one embodiment of the 3D printing pen in the present disclosure;

FIG. 6 is a perspective view of the battery of one embodiment of the 3D printing pen in the present disclosure;

FIG. 7 is another side view of one embodiment of the 3D printing pen in the present disclosure;

FIG. 8 is the still another side view of one embodiment of the 3D printing pen in the present disclosure;

FIG. 9 is a side view of another embodiment of the 3D printing pen in the present disclosure;

FIG. 10 is a circuit diagram of another embodiment of the 3D printing pen in the present disclosure;

FIG. 11 is a structure diagram of the power supply unit of one embodiment of the power supply unit for the 3D printing pen in the present disclosure;

FIG. 12 is a circuit diagram of one embodiment of the power supply unit for the 3D printing pen in the present disclosure.

### DETAILED DESCRIPTION

The following is a clear and detailed description of the technical scheme in the embodiment of the present disclosure by illustrating the attached figures; obviously, the described embodiments are a part of the embodiments of the present disclosure other than all embodiments. Based on the embodiments of the present disclosure, all other embodiments made by those of ordinary skill in the art without creative work belong to the protection scope of the present disclosure.

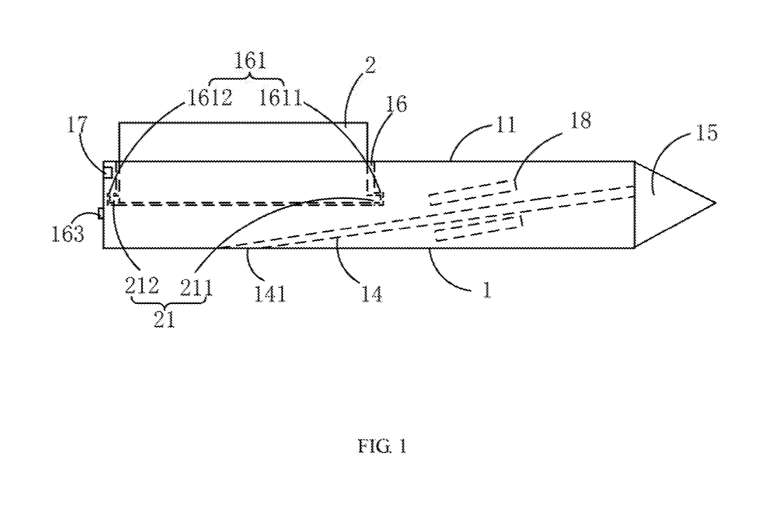

Referring to FIGS. 1-8, one embodiment of the 3D printing pen in the present disclosure includes a printing pen body 1. The printing pen body 1 includes a first shell 11, a first electrical interface 12, a printing circuit 13, and a printing part 15 arranged in the first shell 11.

The first electrical interface 12 is coupled electrically with the printing circuit 13 and used for electrically coupling with a battery 2. The first material inlet 141 and a first material channel 14 are arranged in the first shell 11, and the first material inlet 141, the first material channel 14 and the printing part 15 are communicated in order.

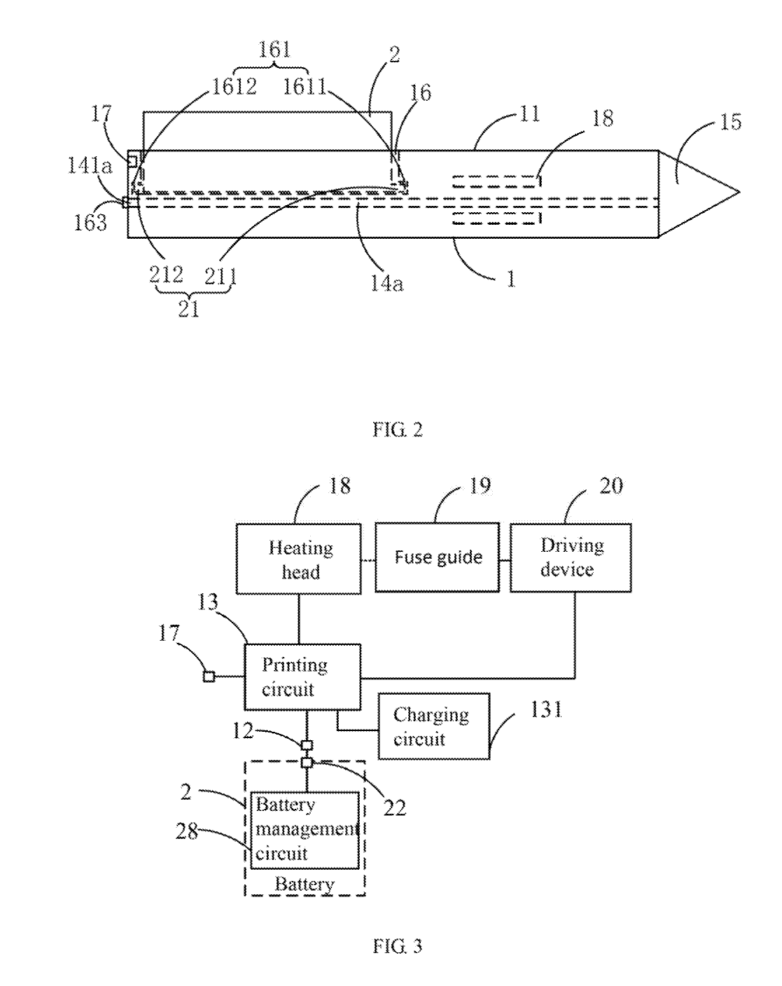

The first shell 11 may have a columnar configuration; the printing part 15 may be arranged at an end of the first shell 11. As shown in FIG. 1, the first material inlet 141 may be disposed in sidewall of the first shell 11, and the first material channel 14 is inclined relative to the first shell 11. In another embodiment, as shown in FIG. 2, the first material inlet 141a may be disposed at the other end of the first shell 11, which is relative to the end providing with the printing part 15, and the first material channel 14a is substantially parallel to an axis of the first shell 11.

The battery 2 can be fixed to the printing pen body 1 all the time, and can also be removed and placed separately. However, the printing pen body 1 and the battery 2 are assembled into a whole at least when the 3D printing pen is printing.

When the 3D printing pen is printing, the battery 2 supplies power for the printing pen body 1 through the first electrical interface 12, for example, providing electric energy for the printing circuit 13, etc. Materials enter the first material channel 14 through the first material inlet 141 so as to enter the printing pen body 1. The materials are output through the printing part 15 for 3D printing after being preprocessed; the preprocessing can be heating, etc. Through the above method, the external plug wire connected when the 3D printing pen works can be unused, overcoming the problem that the 3D printing pen must be connected to the external plug wire in work, resulting in limitation to the scope of writing and printing. The 3D printing pen of the embodiment of the present disclosure and the battery are assembled into a whole in work, with small volume and convenient carryover. The battery is used to supply power, which can cancel the power line and improve the degree of freedom of the movement of the 3D printing pen.

In the embodiment, the printing part 15 is a writing part with fused material outlet. While there are no limitations to the appearance and specific structure of the printing pen, the appearance, structure and set position of the material channel and the mounting position of the battery 2, as long as the printing pen can work properly to achieve the present disclosure after the battery 2 and the printing pen body 1 are assembled to a whole.

Optionally, the printing pen body 1 is provided with a battery compartment 16 holding the battery 2; the first electrical interface 12 is arranged in the battery compartment 16.

In actual application, the battery 2 is arranged in the battery compartment 16 and forms an integral body with the printing pen body 1; the battery 2 supplies power to the printing pen body 1 through the first electrical interface 12. The arrangement position of the first electrical interface 12 in the battery compartment 16 is not limited, as long as the battery 2 is connected to the printing pen body 1 through the first electrical interface 12. The battery 2 can be rechargeable battery or non-rechargeable battery.

There are multiple types of the battery compartment 16, for example, the battery compartment 16 is arranged in the printing pen body 1 (not shown); when installing the battery 2, the printing pen body 1 corresponding to the battery compartment 16 shall be opened; after the battery 2 is placed, the printing pen body 1 is closed. For example, the battery compartment 16 is arranged inside the printing pen body 1 far away from one end of the printing part 15 (not shown), namely that the battery compartment 16 extends to the length direction of the printing pen body 1; the battery 2 is placed into the battery compartment 16 along the extension direction of the battery compartment 16 during installation.

For example, the battery compartment 16 is an open slot defined in the first shell 11. The open slot is defined by a bottom wall and side walls, at least one of the side walls of the open slot is provided with a first engaging part 161. The battery 2 is provided with a second engaging part 21. The battery 2 is placed in the open slot through the second engaging part 21 and the first engaging part 161 detachably.

The first engaging part 161 and the second engaging part 21 are relatively matched and arranged. The battery 2 is fixed in the open slot through the mutual fit of the first engaging part 161 and the second engaging part 21. The engaging manners, such as buckling engaging, concave-convex engaging, bolt engaging, spring engaging or binding engaging, are not limited.

The appearance and structure of the battery compartment 16 are not limited; the design of the battery compartment 16 is consistent with the design of the battery 2 so that the battery compartment 16 can accommodate the battery 2 supplying power for the printing pen body 1 normally.

Optionally, the first electrical interface 12 and the first engaging part 161 are arranged separately. Or the first electrical interface 12 is used as the first engaging part 161, namely that the first electrical interface 12 has two functions of electrical interface and fixation.

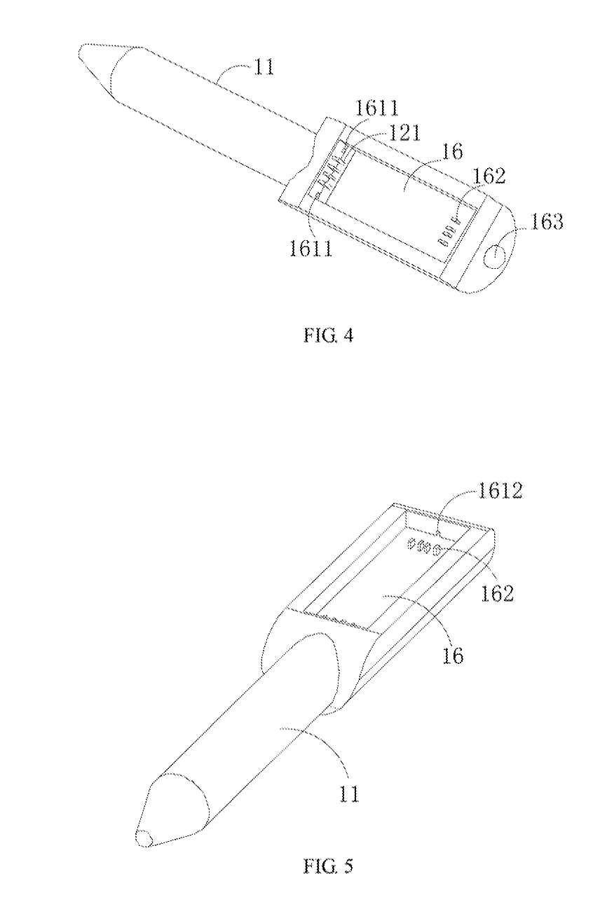

Referring to FIGS. 4-6, optionally, a first groove 1611 and a second groove 1622 are disposed in the first engaging part 161, the first groove 1611 is defined at a side wall of the open slot, the second groove 1612 is defined at another side wall of the open slot, which is opposite to the one provided with the first groove 1611, and the second engaging part 21 comprises a first protrusion 211 and a second protrusion 212, the first protrusion 211 is arranged at a side of the battery 2, and the second protrusion 212 is arranged at another side of the battery 2, which is opposite to the one provided with the first protrusion 211.

The first groove 1611 is matched with the first protrusion 211, and the second groove 1612 is matched with the second protrusion 212 so as to fix the battery 2 to the battery compartment 16.

In this embodiment, the first groove 1611 and the second groove 1622 are arranged at two opposite side walls of the open slot respectively in the length direction of the printing pen body 1 or the width direction of the printing pen body 1. Correspondingly, the first protrusion 211 and the second protrusion 212 are arranged at two opposite sides of the battery respectively. The battery 2 is placed into the open slot during installation; the first groove 1611 is matched with the first protrusion 211, and the second groove 1612 is matched with the second protrusion 212 to finish installation, thereby fixing the battery 2 to the battery compartment 16.

The number of the first grooves 1611 can be one or more, such as 1-10; for example, there are two first grooves 1611 arranged at both sides of the first electrical interface 12 respectively. In a similar way, the number of the second grooves 1612 can be one or more, such as 1-10; for example, there are two second grooves 1612. Correspondingly, the first protrusions 211 are arranged on the battery 2 with a number corresponding to that of the first grooves 1611, and the second protrusions 212 are arranged on the battery 2 with a number corresponding to that of the second grooves 1612.

Referring to FIGS. 4 and 5, optionally, the 3D printing pen includes a spring sheet 162 arranged at the bottom of the open slot close to the second groove 1612. The spring sheet 162 protrudes from the bottom of the open slot in a free state. The second protrusion 212 can retract into the battery 2, and protrude from the battery 2 in the free state.

Referring to FIGS. 1 and 4, the printing pen body 1 is provided with a switch 163. The second protrusion 212 retracts into the battery 2 when the switch 163 is pressed, so that the battery 2 is bounced by the spring sheet 162.

The spring sheet 162 can bounce the battery 2 quickly during removal of the battery 2 to prevent the battery 2 from being pulled out by hand directly or with other tools; it is convenient.

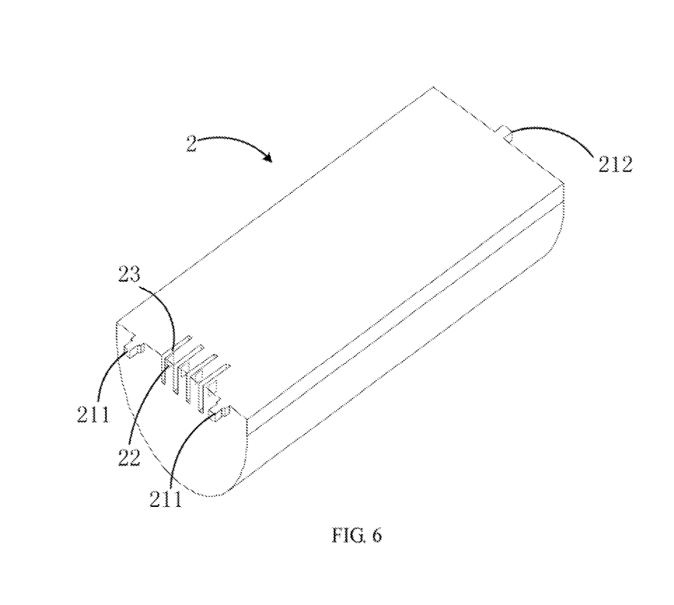

Referring to FIG. 4, optionally, the first electrical interface 12 includes a third protrusion 121 which protrudes from the bottom of the open slot and is close to the first groove 1611. Referring to FIG. 6, the battery 2 is provided with a third groove 23 at the position corresponding to the third protrusion 121. The third groove 23 passes through the side and bottom of the battery 2, which is convenient for the third protrusion 121 to be inserted into the third groove 23 through the side and bottom of the battery 2. The third groove 23 is internally provided with a second electrical interface 22.

The third protrusion 121 can be inserted into the third groove 23 so as to make the first electrical interface 12 electrically connected to the second electrical interface 22.

Referring to FIG. 1 and FIG. 3, optionally, a third electrical interface 17 is arranged on the first shell 11 and used for supplying power for the printing pen body 1 and/or charging the battery 2.

The external voltage source can be used for supplying power for the printing pen body 1 and/or charging the battery 2 through the third electrical interface 17. The battery 2 can also be removed from the printing pen body 1 and charged with other chargers.

Optionally, the third electrical interface 17 is coupled with the printing circuit 13 and used for supplying power for the printing pen body 1 and/or charging the battery 2 through the printing circuit 13.

The external current is used for powering the printing pen body 1 and/or charging the battery 2 through the third electrical interface 17 and the printing circuit 13 in actual 3D printing. Optionally, the printing circuit 13 can be switched to supply power for the printing pen body 1; at the moment, the battery 2 does not need to supply power for the printing pen body 1, or switched to supply power for the battery 2, or switched to supply power for the printing pen body 1 and the battery 2 simultaneously.

Referring to FIG. 3, optionally, the 3D printing pen further includes a charging circuit 131 coupled electrically with the printing circuit 13. The charging circuit 131 can be a part of the printing circuit 13, or the charging circuit 131 and the printing circuit 13 are two arranged side by side.

In actual application, the external current flows the printing circuit 13 and the charging circuit 131 through the third electrical interface 17, and then is used for charging the battery 2 through the second electrical interface 22. The external current can flow the printing circuit 13 through the third electrical interface 17 to supply power for the printing pen body 1 to work. Of course, the charging circuit 131 can also be arranged outside the printing pen body 1, such as in the charger.

Referring to FIG. 3, optionally, the printing pen body 1 includes a heating head 18, a fuse guide device 19 and a driving device 20, wherein the heating head 18 and the driving device 20 are coupled electrically with the printing circuit 13 respectively; the fuse guide device 19 is coupled electrically with the driving device 20.

Specifically, the fuse guide device 19 is used to deliver the materials to the printing part 15 in the first material channel 14, or withdraw the materials far away from the printing part 15.

Specifically, the heating head 18 is used to heat the materials in the first material channel 14. The heating head 18 is used to heat the materials in the first material channel 14 through the electric energy supplied by the battery 2 or the external voltage source into the fused state for the printing part 15 to write or print.

In the actual 3D printing process, the printing circuit 13 is able to control the heating head 18, adjust the parameters of the heating head 18 according to the actual printing conditions, such as the temperature and the heating speed of the heating head 18. The printing circuit 13 is used to control the driving device 20, so as to drive the fuse guide device 19 to work according to the order of the printing circuit 13, so as to control the material delivery speed or direction of the fuse guide device 19.

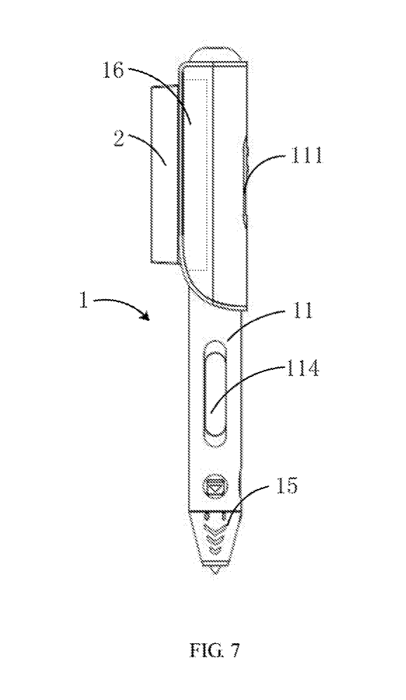

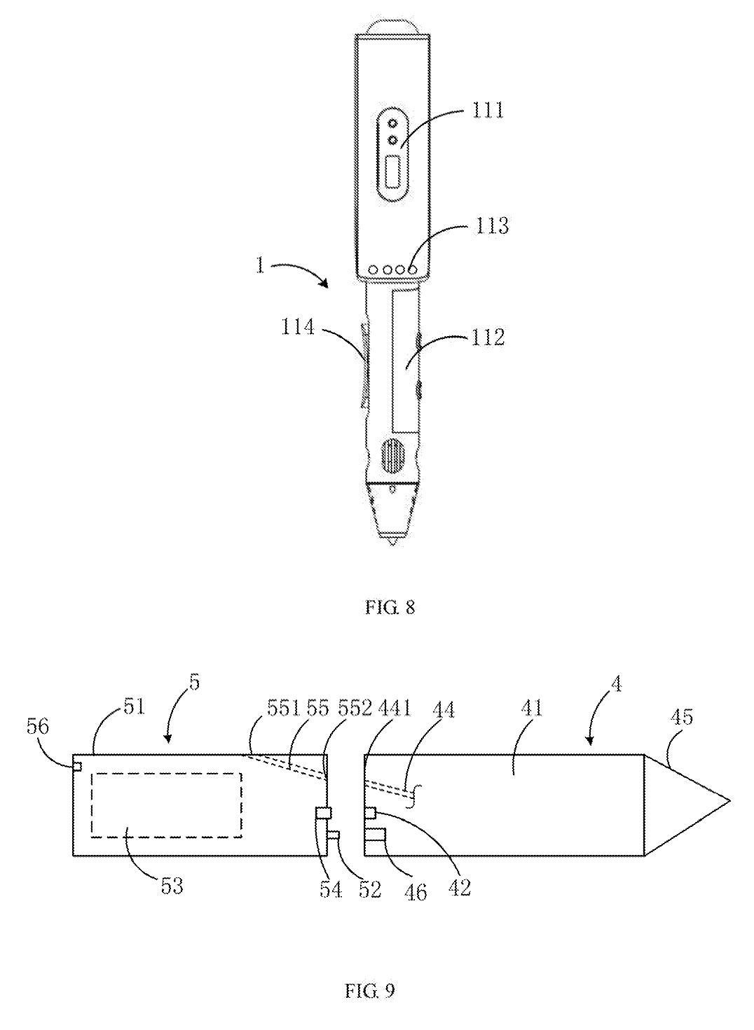

Referring to FIGS. 7 and 8, optionally, the printing pen body 1 is provided with material temperature adjusting buttons 111 including a temperature rise button and a temperature decrease button, used for adjusting the temperature of heating materials in the printing pen body 1, namely that adjusting the heating temperature of the heating head 18, which can increase or decrease the heating temperature. The surface of the first shell 11 is provided with a temperature display component of material temperature adjuster, such as temperature display, used for displaying the real-time temperature of the materials and/or the heating temperature of the heating head 18.

Optionally, the printing pen body 1 is provided with speed control buttons 112, including a high-speed button and a low-speed button, to adjust the material delivery speed of the fuse guide device 19 through the printing circuit 13, so that the fuse material output speed from the printing part 15, namely the writing speed, can be adjusted.

Optionally, the printing pen body 1 is provided with material adjusting buttons 114 used for controlling the materials of the printing part 15 to move forward or backward, including a forward button and a backward button, namely that the fuse guide device 19 is controlled to deliver the materials to the printing part 15 through the printing circuit 13 as forward, and the fuse guide device 19 is controlled to deliver the materials to the opposite direction of the printing part 15 as backward. Generally, the button 114 close to the pen point is the forward button, and that far away from the pen point is the backward button. Of course, the button 114 close to the pen point can also be the backward button, and that far away from the pen point is the forward button.

Optionally, the printing pen body 1, such as the first shell 11 near the battery compartment 16 or the first shell 11 of below the side of the battery compartment 16 near the printing part 15 is provided with a power display component 113, which is able to display the power of the battery 3 in real time, such as display or multiple strip lights. For example, the power display components 113 are 4 strip lights to display the power of the battery 2 in real time; each strip light is corresponding to a through hole of 0.1 mm-2 mm on the first shell 11, without light guide. In other embodiments, the diameter of the through hole may be 0.3 mm-1.8 mm, or 0.6-1 mm. Of course, the power display component 113 can also be arranged on the battery 2 directly. When the battery 2 is placed into the battery compartment 16, the power display component 113 shall face to the port of the batter compartment 16 outward so that the power can be observed.

Referring to FIG. 3, optionally, the 3D printing pen further includes a battery management circuit 28 coupled electrically with the printing circuit 13.

Optionally, the battery management circuit 28 includes an overcurrent protection circuit and an overvoltage protection circuit, and/or a boost circuit and a buck circuit.

Optionally, the battery management circuit 28 is arranged in the battery 2. When arrayed in the battery 2, the battery management circuit 28 is coupled with the printing circuit 13 through the second electrical interface 22 and the first electrical interface 12. The battery management circuit 28 can also be arranged in the printing pen body 1, which can be used for preventing the battery 2 and the printing pen body 1 from being damaged in case of overcurrent or overvoltage during the operation or charging of the 3D printing pen.

Optionally, if the printing circuit 13 fails to detect the printing instruction beyond a first preset time, it will turn off the power consumption function so that the printing pen body 1 enters a low power consumption mode.

The first preset time is 1-100 s, and 2-80 s, 5-60 s, 7-50 s, and 10-40 s are optional.

Optionally, if the battery 2 detects that the duration of the printing circuit 13 in the low power consumption mode exceeds a second preset time, it will turn off boost function.

The second preset time is 1-100 s, and 2-80 s, 3-60 s, 5-50 s, and 7-40 s are optional.

In this embodiment, the power consumption function includes but not limited to the heating function, material transport function, etc. The low power consumption mode refers to that the power consumption function is turned off to make the 3D printing pen in the standby or sleeping state, for example, only the printing circuit 13 is powered on, while other power consumption elements have been turned off

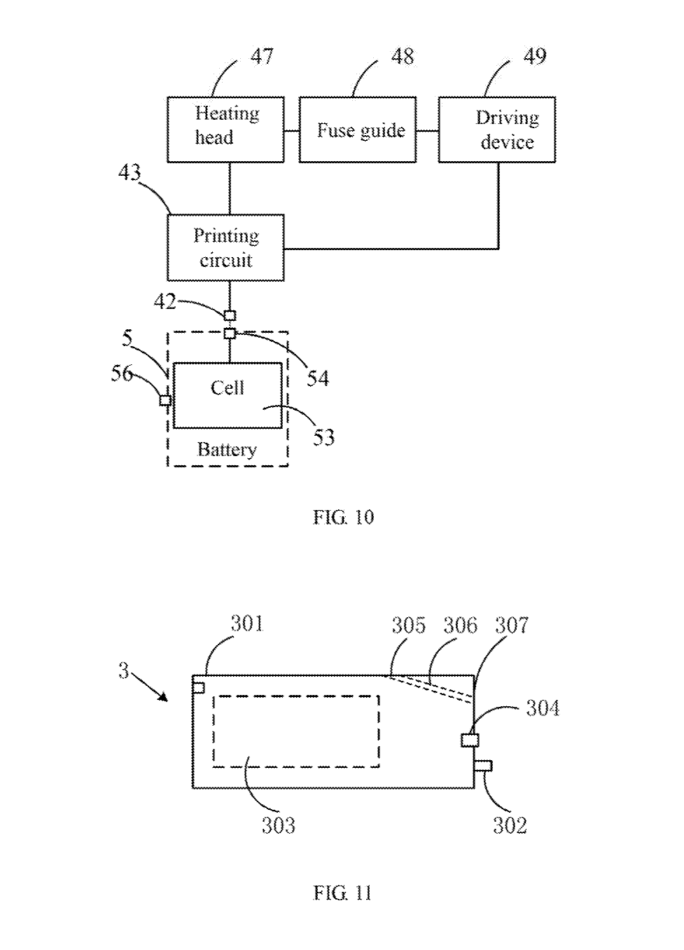

Referring to FIGS. 9-10, another embodiment of the 3D printing pen in the present disclosure is the same as the above embodiment, and the main difference lies in that it includes a printing pen body 4. The printing pen body 4 includes a first shell 41, a first electrical interface 42, a printing circuit 43, and a printing part 45 arranged in the first shell 41.

The first electrical interface 42 is coupled electrically with the printing circuit 43 and used for electrically coupling with the battery 5; the first material inlet 441 and the printing part 45 are arranged in the first shell 41, and the first material inlet 441 and a first material channel 44 are arranged in the first shell 41, and the first material inlet 441, the first material channel 44 and the printing part 45 are communicated in order.

The printing pen body 4 and the battery 5 are assembled into a whole at least when the 3D printing pen is printing.

The battery 5 includes a second shell 51, a fourth engaging part 52, a cell 53, the second electrical interface 54 and the third electrical interface 56. The second electrical interface 54, the cell 53 and the third electrical interface 56 are coupled electrically in order; the third electrical interface 54 is used to couple with voltage source electrically.

The battery 5 and the printing pen body 4 are combined into a whole through the third engaging part 46 and the fourth engaging part 52; the second electrical interface 54 is used to couple with the first electrical interface 42 electrically.

In the actual 3D printing, the cell 53 is located in the second shell 51. The current of the external voltage source flows into the cell 53 through the third electrical interface 56 to charge the battery 5. When the 3D printing pen works, the battery 5 and the printing pen body 4 are combined into a whole through the third engaging part 46 and the fourth engaging part 52, and the current of the battery 5 flows to the first electrical interface 42 of the printing pen body 4 through the second electrical interface 54 to supply power for the printing pen body 4, such as providing power to the printing circuit 43, etc. The materials are delivered to the printing pen body 4 through the first material inlet 441 and the first material channel 44 under the effect of the fuse guide device 48 and the driving device 49, and the heating head 47 changes the materials to the fused state through the electric energy under the control of the printing circuit 43, and the fused materials are used for writing and printing through the printing part 45.

Referring to FIG. 9, optionally, a second material inlet 551, a second material channel 55 and a material outlet 552 are arranged in the battery 5 and are communicated in order; the material outlet 552 is used to communicate with to the first material inlet 551.

The second material channel 55 is arranged on the battery 5, such as on the second shell 51, wherein the second material inlet 551 and the material outlet 552 are the inlet and outlet of the second material channel 55 respectively; the materials used for writing or printing through the printing part 45 are delivered to the second material channel 55 through the second material inlet 551, then to the first material inlet 441 of the printing pen body 4 through the material outlet 552.

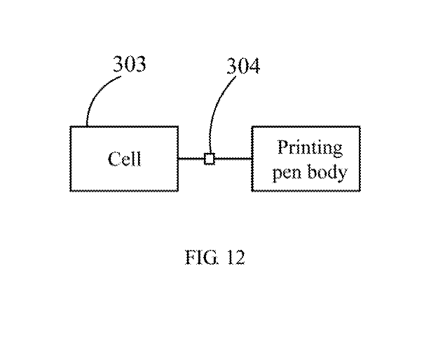

Referring to FIGS. 11 and 12, the power supply unit embodiment for 3D printing pen of the present disclosure includes: a shell 301, an engaging part 302, a cell 303 and an electrical interface 304. The cell 303 is located in the shell 301; the engaging part 302 and the electrical interface 304 are fixed to the shell 301, and the electrical interface 304 and the cell 303 are coupled electrically; wherein, the printing pen body and the power supply unit 3 are combined into a whole through the engaging part 302 at least when the 3D printing pen is printing, so that the electrical interface 304 is coupled electrically with the printing pen body.

The power supply unit 3 further includes a material inlet 305, a material channel 306 and a material outlet 307 which are communicated in order; the material outlet 307 is used to communicate with the printing pen body.

The power supply unit 3 of this embodiment of the power supply unit for the 3D printing pen is the same as the battery of in two embodiments of the 3D printing pen in the present disclosure, and will not be described here.

The above description is only the embodiments of the present disclosure other than limitation to the patent scope of the present disclosure; the equivalent structure or procedure conversion made according to the manual and drawing of the present disclosure, or those directly or indirectly applied to other relevant technical fields are all included into the patent protection range of the present disclosure similarly.

1. A 3D (3-dimensional) printing pen, comprising:
a printing pen body, comprising a first shell, a first electrical interface, a printing circuit, and a printing part arranged in the first shell;
wherein, the first electrical interface is coupled electrically with the printing circuit and configured to electrically couple with a battery, a first material inlet and a first material channel are arranged in the first shell, and the first material inlet, the first material channel and the printing part are communicated in order;
the printing pen body and the battery are combined into a whole at least when the 3D printing pen is printing;
wherein the printing pen body is provided with a battery compartment for holding the battery, and the first electrical interface is arranged in the battery compartment, the battery compartment is an open slot defined in the first shell, a part of the battery is accommodated detachably in the open slot, and the other part of the battery protrudes out of the first shell.

2. (canceled)

3. The 3D printing pen according to claim 1, wherein the open slot is defined by a bottom wall and a side wall, the side wall of the open slot is provided with a first engaging part, the battery is provided with a second engaging part, and the battery is accommodated detachably in the open slot through the first engaging part and the second engaging part.

4. The 3D printing pen according to claim 3, wherein the first electrical interface and the first engaging part are arranged separately; or
the first electrical interface is used as the first engaging part.

5. The 3D printing pen according to claim 3, wherein a first groove and a second groove are disposed in the first engaging part, the first groove is defined at a side wall of the open slot, the second groove is defined at another side wall of the open slot, which is opposite to the one provided with the first groove, and the second engaging part comprises a first protrusion and a second protrusion , the first protrusion is arranged at a side of the battery, and the second protrusion is arranged at another side of the battery, which is opposite to the one provided with the first protrusion;
the first groove is matched with the first protrusion, and the second groove is matched with the second protrusion so as to fix the battery to the battery compartment.

6. The 3D printing pen according to claim 5, wherein comprising a spring sheet arranged at the bottom of the open slot close to the second groove, the spring sheet protrudes from the bottom of the open slot in free state; the second protrusion can retract into the battery, and protrude from the battery in the free state;
the printing pen body is provided with a switch, and the second protrusion retracts into the battery when the switch is pressed, so that the battery is bounced by the spring sheet.

7. The 3D printing pen according to claim 6, wherein the first electrical interface comprises a third protrusion which protrudes from the bottom of the open slot and is close to the first groove; the battery is provided with a third groove at the position corresponding to the third protrusion; the third groove passes through the side and the bottom of the battery and is internally provided with a second electrical interface used for coupling the first electrical interface electrically;
the third protrusion can be inserted into the third groove so as to make the first electrical interface electrically connected to the second electrical interface.

8. The 3D printing pen according to claim 1, wherein a third electrical interface is arranged in the first shell and used to supply power for the printing pen body and/or charging the battery.

9. The 3D printing pen according to claim 8, wherein the third electrical interface is coupled with the printing circuit and used to supply power for the printing pen body and/or charging the battery through the printing circuit.

10. The 3D printing pen according to claim 8, wherein further comprising a charging circuit coupled electrically with the printing circuit.

11. The 3D printing pen according to claim 1, wherein the printing pen body comprises a third engaging part arranged in the first shell;
the battery comprises a second shell, a fourth engaging part, a cell, the second electrical interface and the third electrical interface, the second electrical interface, the cell and the third electrical interface are coupled electrically in order, and the second electrical interface is used to couple with voltage source electrically;
the battery and the printing pen body are combined into a whole through the third engaging part and the forth engaging part, and the second electrical interface is used to couple with the first electrical interface electrically.

12. The 3D printing pen according to claim 10, wherein a second material inlet, a second material channel and a material outlet are arranged in the battery and are communicated in order, and the material outlet is used to communicate with the first material inlet.

13. The 3D printing pen according to claim 1, wherein the printing pen body comprises a heating head, a fuse guide device and a driving device, wherein the heating head and the driving device are coupled electrically with the printing circuit respectively, and the fuse guide device is coupled electrically with the driving device.

14. The 3D printing pen according to claim 1, further comprising a battery management circuit coupled electrically with the printing circuit.

15. The 3D printing pen according to claim 14, wherein the battery management circuit comprises an overcurrent protection circuit and an overvoltage protection circuit; and/or a boost circuit and a buck circuit.

16. The 3D printing pen according to claim 1, wherein when the printing circuit fails to detect the printing order beyond a first preset time, it will turn off power consumption function so that the printing pen body enters a low power consumption mode.

17. The 3D printing pen according to claim 16, wherein when the battery detects that the duration of the printing circuit in the low power consumption mode exceeds a second preset time, it will turn off boost function.

18. A power supply unit for a 3D (3-dimensional) printing pen, comprising a shell, an engaging part, a cell and an electrical interface; wherein the cell is located in the shell, the engaging part and the electrical interface are fixed to the shell, and the electrical interface and the cell are coupled electrically; wherein, the printing pen body and the power supply unit are combined detachably into a whole through the engaging part at least when the 3D printing pen is printing, so that the electrical interface is coupled electrically with the printing pen body, a part of the power supply unit is accommodated in an open slot of the 3D printing pen body, and the other part of the power supply unit protrudes out of the 3D printing pen body.

19. The power supply unit for a 3D printing pen according to claim 18, wherein a material inlet, a material channel and a material outlet are arranged in the power supply unit for 3D printing pen and are communicated in order; the material outlet is used to communicate with the printing pen body.

20. An apparatus, comprising:
a 3D (3-dimensional) printing pen and a battery electrically connected to the 3D printing pen; the 3D printing pen comprising:
a printing pen body, comprising a first shell, a first electrical interface, a printing circuit, and a printing part arranged in the first shell;
wherein, the first electrical interface is coupled electrically with the printing circuit and configured to electrically couple with the battery, a first material inlet and a first material channel are arranged in the first shell, and the first material inlet, the first material channel and the printing part are communicated in order;
the printing pen body and the battery are combined into a whole at least when the 3D printing pen is printing;
wherein the printing pen body defines a battery compartment for holding the battery, and the first electrical interface is arranged in the battery compartment, the battery compartment is an open slot defined in the first shell, a part of the battery is accommodated detachably in the open slot, and the other part of the battery protrudes out of the first shell;
wherein the open slot is defined by a bottom wall and a side wall, the side wall of the open slot is provided with a first engaging part, the battery is provided with a second engaging part, and the battery is accommodated detachably in the open slot through the first engaging part and the second engaging part, the first electrical interface is used as the first engaging part;
wherein a first groove and a second groove are disposed in the first engaging part, the first groove is defined at a side wall of the open slot, the second groove is defined at another side wall of the open slot, which is opposite to the one provided with the first groove, and the second engaging part comprises a first protrusion and a second protrusion , the first protrusion is arranged at a side of the battery, and the second protrusion is arranged at another side of the battery, which is opposite to the one provided with the first protrusion;
the first groove is matched with the first protrusion, and the second groove is matched with the second protrusion so as to fix the battery to the battery compartment.
